(19) United States
(12) Patent Application Publication
(10) Pub. No.: US 2023/0254672 A1
(43) Pub. Date: Aug. 10, 2023

(54) A Method of Communicating Elevation Information In C-V2X

(71) Applicant: QUALCOMM Incorporated, San Diego, CA (US)

(72) Inventors: Yue YIN, Beijing (CN); Shuping CHEN, Beijing (CN); Yan LI, Beijing (CN)

(21) Appl. No.: 18/003,574

(22) PCT Filed: Apr. 9, 2021
(86) PCT No.: PCT/CN2021/086163

§ 371 Date: Dec. 28, 2022

(30) Foreign Application Priority Data
Jul. 2, 2020 (WO) PCT/CN2020/099914

(51) Int. Cl. H04W 4/46; G01S 19/42

(52) U.S. Cl. CPC H04W 4/46; G01S 19/42

(57) ABSTRACT

Various embodiments provide methods, vehicle computing devices, storage media, and systems for providing position information when broadcasting Broadcast Safety Messages (BSMs), which may include determining an elevation of the vehicle by a global navigation satellite system (GNSS) receiver, determining a quantized elevation value (or a representative elevation value) based on the determined elevation, generating a BSM that includes the quantized elevation value, and broadcasting the BSM for reception by other vehicles. Alternatively or in addition, the vehicle computing device may be configured to use a group key to encrypt the elevation information that is included in the BSM.

### RELATED APPLICATIONS

This application is a national stage application of and claims the benefit of priority to PCT application PCT/CN2021/086163 entitled “A Method of Communicating Elevation Information in C-V2x” filed Apr. 9, 2021, which claims the benefit of priority to PCT Application PCT/CN2020/099914 entitled “A Method of Communicating Elevation Information in C-V2x” filed Jul. 2, 2020, the entire contents of both of which are hereby incorporated by reference for all purposes.

### BACKGROUND

Cellular and wireless communication technologies have seen explosive growth over the past several years and are being used to support communications between a host of different types of communication devices, such as smartphones, vehicle-based communication devices, infrastructure communication devices, network communication devices, etc. This growth has been fueled by better communications hardware, larger networks, and more reliable protocols.

The surface transportation industry has increasingly looked to leverage the growing capabilities of cellular and wireless communication technologies through the adoption of Intelligent Transportation Systems (ITS) technologies to increase intercommunication and Safety for both driver-operated vehicles and autonomous vehicles. The cellular vehicle-to-everything (C-V2X) protocol defined by the 3rd Generation Partnership Project (3GPP) supports ITS technologies and serves as the foundation for vehicle-based wireless communications. In particular, C-V2X defines two transmission modes that, together, provide a 360° non-line-of-sight awareness and a higher level of predictability for enhanced road safety and autonomous driving. A first transmission mode includes direct C-V2X, which includes vehicle-to-vehicle (V2V), vehicle-to-infrastructure (V2I), and vehicle-to-pedestrian (V2P), and that provides enhanced communication range and reliability in the dedicated ITS 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G NR systems, etc.), etc.

Of particular usefulness to autonomous driving are the V2V communications between or among motor vehicles. V2V systems and technologies hold great promise for improving traffic flows and vehicle safety by enabling vehicles to share information regarding their position, speed, direction of travel, braking, and other factors that may be useful to other vehicles for anti-collision and other safety functions. Vehicles equipped with V2V onboard equipment may collect and use Global Positioning System (GPS) or Global Navigation Satellite System (GNSS) receivers to determine their positions, and transmit the position information (e.g., a latitude, a longitude and an elevation value) in packets referred to as Basic Safety Messages (BSM).

### SUMMARY

Various aspects include methods performed in a processor of a vehicle for providing position information when broadcasting Broadcast Safety Messages (BSMs). Various aspects may include determining an elevation of the vehicle by a global navigation satellite system (GNSS) receiver, determining a quantized elevation value based on the determined elevation, the quantized elevation value being less precise than the determined elevation but with sufficient precision to inform other vehicles of a roadway level on which the vehicle is traveling, and broadcasting the BSM that includes the quantized elevation value for reception by other vehicles. In some aspects, determining the quantized elevation value based on the determined elevation, the quantized elevation value being less precise than the determined elevation but with sufficient precision to inform other vehicles of the roadway level on which the vehicle is traveling may include dividing the determined elevation by an integer step value to generate a quotient, and rounding the quotient to an integer or whole number. In some aspects, dividing the determined elevation by the integer step value to generate the quotient may further include determining the integer step value so that the resulting quantized elevation values are sufficiently generalized (or made less accurate) so that broadcast elevation information complies with the relevant regulations. In some aspects, dividing the determined elevation by the integer step value to generate the quotient may further include determining the integer step value so that the resulting quantized elevation values are sufficiently precise to inform other vehicles whether the vehicle is at grade (at ground level) or of the number of roadway levels that the vehicle is above or below grade. In some aspects, the integer step value may be three meters. In some aspects, broadcasting the BSM that includes the quantized elevation value may include broadcasting a BSM that includes an integer between −1229 and 18432 representing the number of steps above or below a reference ellipsoid.

Further aspects may include obtaining map information, determining an elevation of the vehicle by a global navigation satellite system (GNSS) receiver, determining a representative elevation value by comparing the determined elevation to the obtained map information, generating a BSM that includes the representative elevation value, and broadcasting the BSM for reception by other vehicles. In some aspects, determining the representative elevation value by comparing the determined elevation to the obtained map information may include determining a representative value that indicates whether the vehicle is at grade (at ground level), a number of roadway levels that the vehicle is below grade, or a number of roadway levels that the vehicle is above grade. In some aspects, generating the BSM that includes the representative elevation value may include generating the BSM to include a quantized elevation value (e.g., an integer between −8 and 8, inclusive etc.) that represents the number of steps or roadway levels that the vehicle is above or below a reference point/grade. In some aspects, obtaining the map information may include one or more of receiving map information from a vehicle-to-everything (V2X) MAP message, downloading map information from a third-party vendor, or accessing map information preloaded in local memory. determining the representative elevation value by comparing the determined elevation to the obtained map information may include determining the representative elevation value by comparing the determined elevation to a three-dimensional map. In some aspects, determining the representative elevation value by comparing the determined elevation to the obtained map information may include determining the representative elevation value based on a two-dimensional map and simple reckoning.

Further aspects may include determining an elevation of the vehicle by a global navigation satellite system (GNSS) receiver, generating an encrypted elevation value based on the determined elevation, generating a BSM that includes the encrypted elevation value, and broadcasting the BSM for reception by other vehicles. In some aspects, generating the encrypted elevation value based on the determined elevation may include using a simple encryption algorithm, such as Advanced Encryption Standard (AES) or a symmetric-key algorithm, to reduce processing and communication resources used to encrypt, transmit and/or decrypt the elevation. Some aspects may further include using a certification process to obtain permissions necessary to transmit the encrypted elevation value. In some aspects, generating the encrypted elevation value based on the determined elevation may include using a group encryption key that is provided to every approved receiver device or vehicle in advance of the broadcast.

Further aspects include a vehicle including a vehicle computing device having a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a computing device for use in a vehicle and configured to perform operations of any of the methods summarized above. Further aspects include a vehicle having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A and 1B are component block diagrams illustrating a vehicle suitable for implementing various embodiments.

FIG. 1C illustrates an example C-V2X system suitable for implementing various embodiments.

FIG. 2 is a system block diagram illustrating components of a vehicle computing device in communication with road side units and other vehicles suitable for implementing various embodiments.

FIG. 3 is a block diagram illustrating components of an example system on chip for use in a vehicle that may be configured to broadcast, receive, and/or otherwise use C-V2X messages in accordance with various embodiments.

FIG. 4 is a component block diagram illustrating a system configured for sending position information in accordance with various embodiments.

FIG. 5 is a process flow diagram illustrating a method of broadcasting quantized elevation information in BSMs according to some embodiments.

FIG. 6 is a process flow diagram illustrating a method of broadcasting elevation information based on map information in BSMs according to some embodiments.

FIG. 7 is a process flow diagram illustrating a method of broadcasting encrypting elevation information in BSMs according to some embodiments.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods for broadcasting vehicle altitude or elevation information with obfuscation or encryption so as to comply with government regulations limiting open broadcast of actual vehicle elevation information.

As used herein, the term “Road Side Unit” (or “RSU”) refers to highway computing systems that include a processor configured to perform C-V2X communications and similar operations. Road Side Units may be part of a C-V2X communication network or system.

As used herein, the term “communication device” refers to any one or all of cellular telephones, smartphones, portable computing devices, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein. While the various aspects are particularly useful for in-vehicle communication systems and/or computing devices, the aspects are generally useful in any communication device that includes communication circuitry for communicating with Road Side Units and a processor that executes application programs.

The term “system-on-chip” (SoC) is used herein to refer to a set of interconnected electronic circuits typically, but not exclusively, including one or more processors, a memory, and a communication interface. The SoC may include a variety of different types of processors and processor cores, such as a general purpose processor, a central processing unit (CPU), a digital Signal processor (DSP), a graphics processing unit (GPU), an accelerated processing unit (APU), a sub-system processor, an auxiliary processor, a single-core processor, and a multicore processor. The SoC may further embody other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the integrated circuit reside on the same substrate, such as a single piece of semiconductor material (e.g., silicon, etc.).

The term “system in a package” (SIP) is used herein to refer to a single module or package that may contain multiple resources, computational units, cores and/or processors on two or more integrated circuit (IC) chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high speed communication circuitry and packaged in close proximity, such as on a single motherboard or in a single mobile communication device. The proximity of the SoCs facilitates high speed communications and the sharing of memory and resources.

In cellular vehicle-to-everything (C-V2X) communication protocols, each in-vehicle communication device is expected to support the transmission and reception of Basic Safety Messages (BSMs). A vehicle may use BSMs to inform other vehicles, as well as the surface transportation network and road side units, of the vehicle's status, location, position, direction of travel, speed, etc. so that the vehicles can avoid collisions. BSMs also inform the surface transportation network of the locations and speeds of vehicles on the roadway, enabling the system to identify safety concerns, traffic jams, etc.

BSMs are self-contained messages between 190-400 bytes in length that are transmitted frequently in V2X systems so that other vehicles and road side units are kept informed about each vehicle's position and state. For example, BSMs may be sent every 100 milliseconds (ms), and each BSM may include a position information field that includes a latitude value, a longitude value and an elevation value. The elevation value may be an integer between −4096 and 61439 that represents ten-centimeter (cm) steps above or below a reference ellipsoid. This provides a range of −409.5 to +6143.0 meters with an accuracy/precision of 10 cm. The elevation value “−4096” may also be used to indicate that the elevation of the vehicle's position is unknown.

Some concepts for including precise elevation data in BSMs report elevation as an indicator of one of an elevation interval (e.g., 50, 100, 150, etc. meters) above a reference point in combination with an offset from the indicated elevation interval. For example, such concepts would generate BSMs that report precise elevation information using a set of elevation intervals (e.g., 50, 100, 150, etc. meters) above a reference point and an offset from the nearest elevation interval so as to communicate a precise elevation value (e.g., to within 10 cm) using fewer bytes of information than would be required to communicate all digits of the elevation data.

It is important to include elevation information in the BSMs to enable other vehicles to avoid collisions as well as recognize when collisions are not possible because another vehicle is on a roadway above or below (e.g., in an overpass or “fly over” roadway configuration). Many transportation networks include overpasses and flyovers, or otherwise use grade separations to align junctions of two or more surface transport axes at different elevations (grades) to optimize traffic flow. Without elevation information, a vehicle approaching an overpass or other grade separation may not be able to determine whether an approaching vehicle is at the same elevation (or grade, layer, etc.) as the vehicle. A collision may occur if vehicles are crossing an at grade-intersection and incorrectly determine that they are crossing an overpass on different grades. Similarly, two vehicles crossing an overpass on different grades may incorrectly determine that the vehicles are on course for collision, and issue a false-alarm or perform other actions (e.g., apply the brakes, stop the vehicle, etc.) that a human driver would deem inappropriate in those circumstances.

While it is important to include position information (e.g., longitude, latitude, elevation, etc.) in a BSM, certain regulations or technical challenges may prevent an in-vehicle communication device from transmitting highly accurate or precise position information. For example, due to security concerns, the over the air transmission of precise elevation information (or raw longitude and latitude values, etc.) is currently prohibited in China. Since the evaluation information included in a conventional BSM is precise to within 10 cm, broadcast of conventional BSMs in China would be illegal.

Various embodiments include an in-vehicle communication device that may configured to generate BSMs in a manner that complies with such regulations (e.g., China security regulations, etc.) and which may be used to determine the position (e.g., latitude, longitude, elevation, altitude, grade, layer, etc.) of the vehicle.

In some embodiments, the in-vehicle communication device may be configured to quantize elevation information to generate information that is less precise than the elevation information included in conventional BSMs but which is sufficiently precise to inform other vehicles approaching the same overpass or grade separation whether the vehicles are at the same or different elevation (or grade, layer, etc.) as the vehicle.

For example, the in-vehicle communication device may use a GPS or GNSS receiver to determine the elevation of the vehicle with a high degree of precision (e.g., within 10 cm, etc.). The in-vehicle communication device may determine a quantized elevation value based on the GPS or GNSS receiver determined elevation value, such as by dividing the GPS or GNSS receiver determined elevation value by an integer step value (e.g., by 3 meters, etc.) and rounding the results to an integer or whole number to generate the resulting quantized elevation value.

In some embodiments, the in-vehicle communication device may be configured to intelligently select the integer step value so that the resulting quantized elevation values are sufficiently generalized (or made less precise) so that the elevation information complies with the relevant regulations, but is still sufficiently precise to inform other vehicles whether the vehicle is below grade (−3), at grade (0), one roadway level above grade (3), two roadway levels above grade (6), etc.

In some embodiments, the in-vehicle communication device may be configured to generate the BSM to include a quantized elevation value that is an integer between −1229 and 18432 representing the number of steps above or below a reference ellipsoid. For a step size of 3 meters, the quantized elevation value may provide a range of −409.3 to +6144 meters with an accuracy/precision of 3 meters. In these embodiments, the elevation value “−1229” may be used to indicate that the elevation of the vehicle's position is unknown.

In some embodiments, the in-vehicle communication device may be configured to use a map (e.g., 2D map, 3D map, etc.) to determine its current grade (e.g., altitude, layer, level, elevation, etc.) and/or the grade of other vehicles. For example, in some embodiments, the in-vehicle communication device may obtain map information from a V2X MAP message, download a map from a third-party vendor, or access a map preloaded in its local memories. The in-vehicle communication device may compare its GPS or GNSS receiver determined elevation value to elevation layers in a three-dimensional (3D) map to determine its current elevation relative to reference point/grade and/or to determine the whether it is currently at the same grade (or elevation, layer, etc.) as another vehicle. Alternatively, the in-vehicle communication device may use a two-dimensional map in conjunction with reckoning (e.g., “dead reckoning,” “deduced reckoning,” etc.) techniques, and/or trilateration to determine its current elevation relative to reference point/grade and/or to determine the whether it is currently at the same grade (or elevation, layer, etc.) as another vehicle. The in-vehicle communication device may generate the BSM to include an elevation value (e.g., an integer between −8 and 8, inclusive etc.) that represents the number of steps or roadway levels that the vehicle is above or below a reference point/grade. For example, an elevation value of negative one (−1) may indicate that the vehicle is in a tunnel one level below the ground, an elevation value of zero (0) may indicate that the vehicle is on the ground, and an elevation value of one (1) may indicate that the vehicle is on a bridge or overpass one level above ground.

In some embodiments, the in-vehicle communication device may be configured to collect and use a GPS or GNSS receiver to determine the elevation of the vehicle to a high degree of precision, and “encrypt” or “transform” the determined elevation value before including it in the BSM and transmitting the BSM over the air. In some embodiments, the in-vehicle communication device may be configured to use a simple encryption algorithm, such as Advanced Encryption Standard (AES) or a symmetric-key algorithm, to reduce the processing and communication resources that are used to encrypt, transmit and/or decrypt the elevation information included in the BSM. In some embodiments, the encryption key may be distributed by a regulator. In some embodiments, a certification process may be used to obtain permissions necessary to transmit the encrypted elevation information included in the BSM. In some embodiments, the encryption key may be a group key that is provided to every approved receiver device in advance of the transmission, and which may be used by receiver devices to decipher/decrypt the encrypted elevation information included in a received BSM.

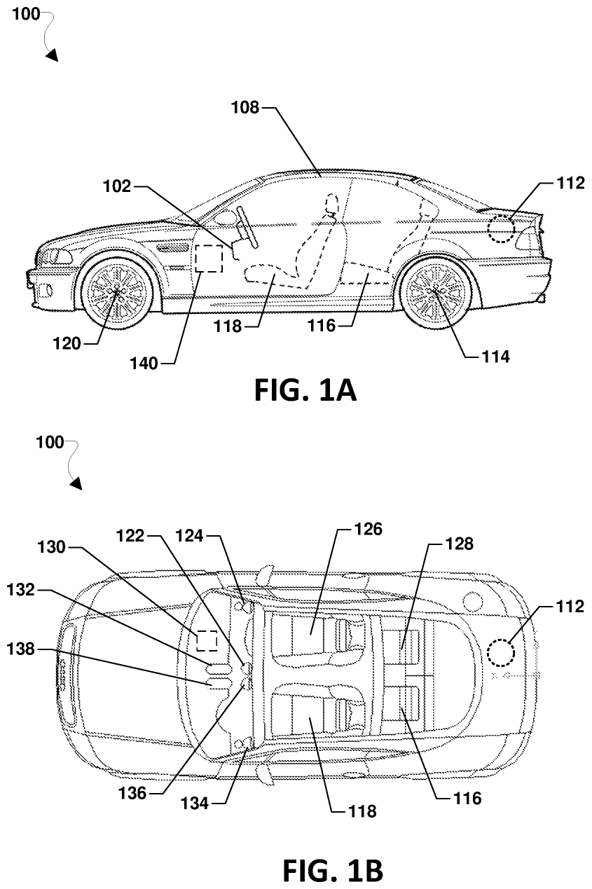

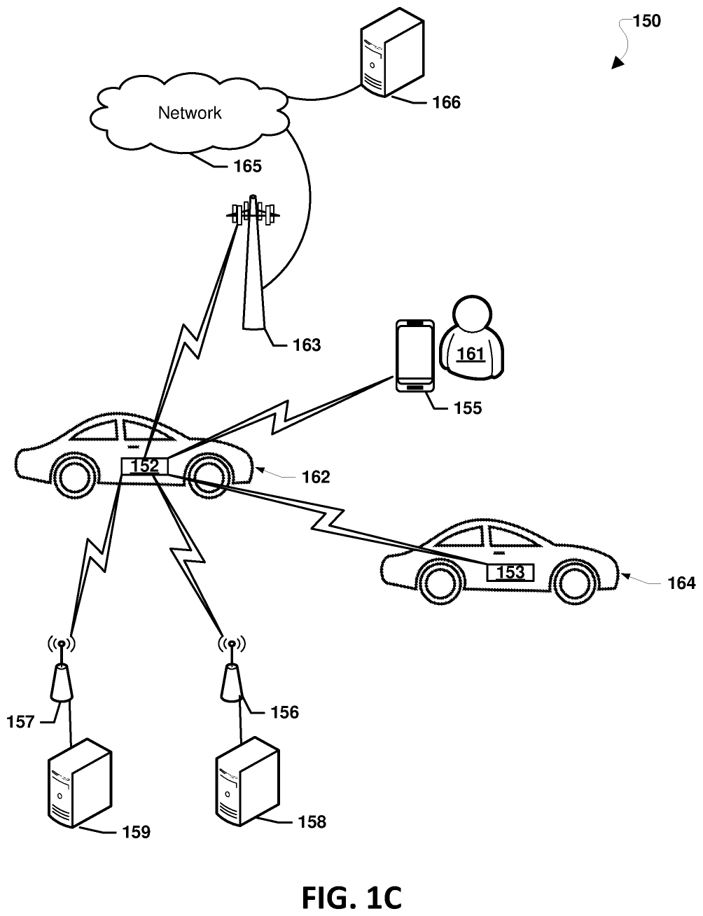

Various embodiments may be implemented within a variety of vehicles, an example vehicle 100 of which is illustrated in FIGS. 1A and 1B. With reference to FIGS. 1A and 1B, a vehicle 100 may include a vehicle computing device 140 (also referred to as an in-vehicle communication device) and a plurality of sensors 102-138, including satellite geopositioning system receivers 108, occupancy sensors 112, 116, 118, 126, 128, tire pressure sensors 114, 120, cameras 122, 136, microphones 124, 134, impact sensors 130, radar 132, and lidar 138.

The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a vehicle computing device 140, as well as with each other. In particular, the sensors may include one or more cameras 122, 136 or other optical sensors or photo optic sensors. The sensors may further include other types of object detection and ranging sensors, such as radar 132, lidar 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle computing device 140, which is sometimes referred to as an onboard unit (OBU), may be configured with processor-executable instructions to perform various embodiments using information received from various sensors, particularly the cameras 122, 136. In some embodiments, the vehicle computing device 140 may supplement the processing of camera images using distance and relative position (e.g., relative bearing angle) that may be obtained from radar 132 and/or lidar 138 sensors. The vehicle computing device 140 may further be configured to control steering, breaking and speed of the vehicle 100 when operating in an autonomous or semi-autonomous mode using information regarding other vehicles determined using various embodiments.

FIG. 1C illustrates an example C-V2X system 150 suitable for implementing various embodiments. With reference to FIGS. 1A-1C, a C-V2X system 150 may include an in-vehicle communication device 152 (also referred to as a vehicle computing device) configured to exchange wireless communications with other communication devices around a vehicle 162 in which the in-vehicle communication device 152 is located. The vehicle 162 may be any type of vehicle, such as an autonomous vehicle (e.g., driverless car, etc.), semi-autonomous vehicle, remotely operated vehicle, etc. The in-vehicle communication device 152 may be a computing device mounted in the vehicle 162 or may be a mobile communication device (e.g., a smartphone, laptop, etc.) temporarily placed within the vehicle 162. The C-V2X system 150 may include various devices in addition to the in-vehicle communication device 152, such as another in-vehicle communication device 153 (also referred to as a vehicle computing device) of another vehicle 164, transmitters 156 and 157 connected to Road Side Units 158, 159, communication device 155 (e.g., a smartphone, laptop, etc.), cellular tower or base station 163 connected to a network 165 and network server 166, etc. Various components of the C-V2X system 150 may be configured to operate as an ITS network to support intercommunication and Safety for surface vehicles.

The in-vehicle communication device 152 may be configured to perform vehicle-to-vehicle (V2V) communications, vehicle-to-infrastructure (V2I) communications, and vehicle-to-pedestrian (V2P) communications. For example, the in-vehicle communication device 152 may establish a device-to-device (D2D) link with another in-vehicle communication device 153 of another vehicle 164 to exchange V2V communications. As another example, the in-vehicle communication device 152 may establish D2D links with transmitters 156 and 157 connected to Road Side Units 158, 159 to exchange V2I communications. As a further example, the in-vehicle communication device 152 may establish a D2D link with the communication device 155, such as a smartphone, laptop, etc., of a user 161 to exchange V2P communications. The D2D links between the in-vehicle communication device 152, the in-vehicle communication device 153, the communication device 155, the Road Side Units 158, 159 may be communication links established independent of a cellular network, such as links establish in the dedicated ITS 5.9 gigahertz (GHz) spectrum. As specific examples, the D2D links may be dedicated short range communication (DSRC) links, LTE direct (LTE-D) links, or any other type link supporting direct device communication.

The in-vehicle communication device 152 may be configured to perform vehicle-to-network (V2N) communications. For example, the in-vehicle communication device 152 may establish network-to-device links with a cellular tower or base station 163 connected to a network 165 and other vehicles 164 to exchange V2N communications. The network-to-device links may include, without limitation, uplinks (or reverse links), downlinks (or forward links), bidirectional links, etc. The network-to-device links may be established according to mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G) (e.g., 5G New Radio (5G NR) systems, etc.), etc.

In some embodiments, the in-vehicle communication device 152 and the cellular tower or base station 163 may include 5G NR functionality with an air interface based on orthogonal frequency division multiplexing (OFDM). The functionality of the cellular tower or base station 163 may be similar in one or more aspects to (or incorporated into) the functionality of a cellular IoT (CIoT) base station (C-BS), a NodeB, an evolved NodeB (eNodeB), radio access network (RAN) access node, a radio network controller (RNC), a base station (BS), a macro cell, a macro node, a Home eNB (HeNB), a femto cell, a femto node, a pico node, or some other suitable entity based on the radio technology used to establish the network-to-device links between the cellular tower or base station 163 and the in-vehicle communication device 152. The cellular tower or base station 163 may be in communication with respective routers that may connect to the network 165 (e.g., core network, Internet, etc.). Using the connections to the cellular tower or base station 163, the in-vehicle communication device 152 may exchange data with the network 165 as well as devices connected to the network 165, such as other vehicles 164 or any other communication device connected to the network 165.

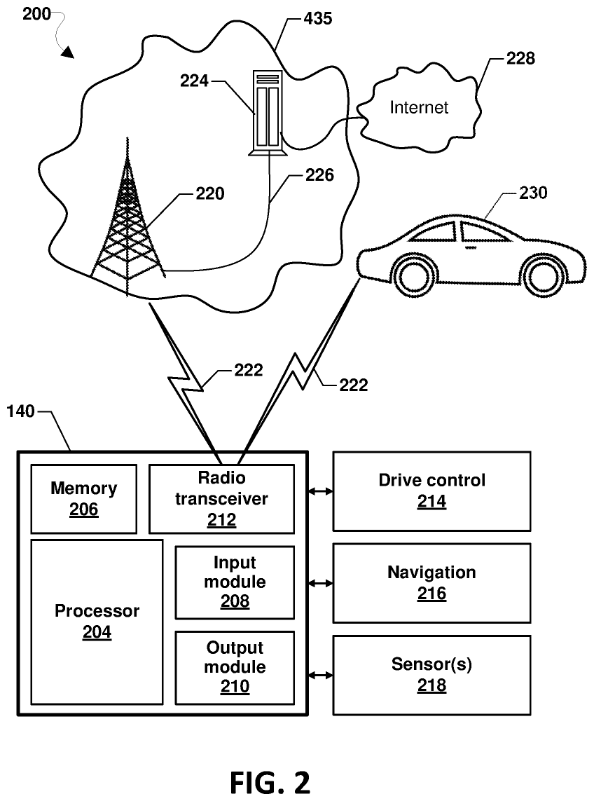

FIG. 2 is a component block diagram illustrating a system 200 of components and support systems suitable for implementing various embodiments. With reference to FIGS. 1A-2A, the system 200 may include vehicle computing devices 140 (and/or 152, 153) in vehicles 100, 162, 164, 230 that are configured to communicate via wireless communications (e.g., C-V2X protocol messages 222, such as BSM messages, etc.) with other vehicles and road side units 220, and road side units 220 may communicate with network servers 224 (e.g., via wireless or wired communication links 226).

The road side units 220, the network servers 224 and the wired 226 and wireless communication links connecting such units together into an integrated communication and tracking system may comprise and are referred to generally herein as a surface transportation network 435. Network servers 224 of the surface transportation network 435 may be coupled to wide area network, such as the Internet 228, and be configured to route permanent vehicle information to computing platforms of authorized parties and a certificate authority 430 using any of a variety of known network message transport protocols.

A vehicle computing device 140 (and/or 152, 153), which may include various circuits and devices used to control the operation of the vehicle 100, 162, 164, 230 as well as communicate with other devices within a surface transportation network 200.

In the example illustrated in FIG. 2, the vehicle computing device 140 (and/or 152, 153) includes a processor 204, memory 206, an input module 208, an output module 210 and a radio transceiver 212. The vehicle computing device 140 (and/or 152, 153) may be coupled to and configured to control drive control components 214, navigation components 216, and one or more sensors 218 of the vehicle 100, 162, 164, 230. The processor 204 that may be configured with processor-executable instructions to control maneuvering, navigation, and/or other operations of the vehicle 100, 162, 164, 230, including operations of various embodiments. The processor 204 may be coupled to the memory 206. The vehicle computing device 140 (and/or 152, 153) may include the input module 208, the output module 210, and the radio transceiver 212.

The radio transceiver 212 may be configured to transmit and receive C-V2X protocol messages (e.g., BSMs) with road side units 220 and other vehicles 230.

The input module 208 may receive sensor data from one or more vehicle sensors 218 as well as electronic signals from other components, including the drive control components 214 and the navigation components 216. The output module 210 may be used to communicate with or activate various components of the vehicle 100, 162, 164, 230, including the drive control components 214, the navigation components 216, and the sensor(s) 218.

The vehicle computing device 140 (and/or 152, 153) may be coupled to the drive control components 214 to control physical elements of the vehicle 100, 162, 164, 230 related to maneuvering and navigation of the vehicle, such as the engine, motors, throttles, steering elements, flight control elements, braking or deceleration elements, and the like. The drive control components 214 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The vehicle computing device 140 (and/or 152, 153) may be coupled to the navigation components 216, and may receive data from the navigation components 216 and be configured to use such data to determine the present position and orientation of the vehicle 100, 162, 164, 230, as well as an appropriate course toward a destination. In various embodiments, the navigation components 216 may include or be coupled to a global navigation satellite system (GNSS) receiver (e.g., a Global Positioning System (GPS) receiver) enabling the vehicle 100, 162, 164, 230 to determine its current position using GNSS signals. Alternatively, or in addition, the navigation components 216 may include radio navigation receivers for receiving navigation beacons or other signals from radio nodes, such as Wi-Fi access points, cellular network sites, radio station, remote computing devices, other vehicles, etc. Through control of the drive control elements 214, the processor 204 may control the vehicle 100, 162, 164, 230 to navigate and maneuver. The processor 204 and/or the navigation components 216 may be configured to communicate with a road side unit 230 to receive commands to control maneuvering, receive data useful in navigation, provide real-time position reports, and assess other data.

The vehicle computing device 140 (and/or 152, 153) may be coupled to one or more sensors 218. The sensor(s) 218 may include the sensors 102-138 as described, and may the configured to provide a variety of data to the processor 204.

The processor 204 of the vehicle computing device 140 (and/or 152, 153) may be configured to receive information regarding the vehicle's position and direction of travel (e.g., from navigation components 216), speed (e.g., from drive control components 214), and other information (e.g., from sensor(s) 218) and generate C-V2X messages, such as BSMs, PermanentIDInformationMessages, etc., for transmission by the radio transceiver 212. For example, BSMs inform other vehicles 230 as well as the surface transportation network 200 via road side units 220 of the vehicle's status, position, direction of travel and speed so that other vehicles, such as autonomous vehicles, can avoid collisions. BSMs also inform the surface transportation network 200 of the locations and speeds of vehicles on the roadway, enabling the system to identify safety concerns, traffic jams, etc. BSMs may be transmitted frequently so that other vehicles 230 and road side units 220 are kept informed about the vehicles position and state.

The processor 204 of the vehicle computing device 140 (and/or 152, 153) may be configured to receive BSMs from other vehicles 230 and use such information in controlling vehicle operations (e.g., providing other vehicle positions to drive control components 214 and/or navigation components 216). The processor 204 may also be configured to receive and process other C-V2X messages from road side units 220, and PermanentIDInformationRequestMessages, and use the information in such messages and use such information in controlling vehicle operations, notifying the operator of safety conditions, etc.

In various embodiments, the processor 204 may include permanent vehicle identification information in C-V2X messages that will be received by road side units 220, such as BSMs, PermanentIDInformationMessages, etc. The road side units 220 may be configured to forward C-V2X messages including permanent vehicle identification information, as well as other information, to a server 224 of the surface transportation network 220. The road side units 220 may forward the information as C-V2X messages and/or in other type messages. The server 224 may be configured to forward permanent vehicle identification information, as well as other information, obtained from vehicle C-V2X messages, to an appropriate authorized party, such as law enforcement. In some embodiments, the vehicle C-V2X messages may include an indication of the circumstance or condition triggering the need to transmit permanent vehicle identification information in vehicle C-V2X messages, which information the server 224 to determine the appropriate authorized party to which the permanent vehicle identification information and other vehicle information should be routed. In some embodiments, the vehicle C-V2X messages may identify how permanent vehicle identification information and other information in vehicle C-V2X messages should be routed to the appropriate authorized party, such as an Internet address.

While the vehicle computing device 140 (and/or 152, 153) is described as including separate components, in some embodiments some or all of the components (e.g., the processor 204, the memory 206, the input module 208, the output module 210, and the radio transceiver 212) may be integrated in a single device or module, such as a system-on-chip (SOC) processing device. Such an SOC processing device may be configured for use in vehicles and be configured, such as with processor-executable instructions executing in the processor 204, to perform operations of various embodiments when installed into a vehicle

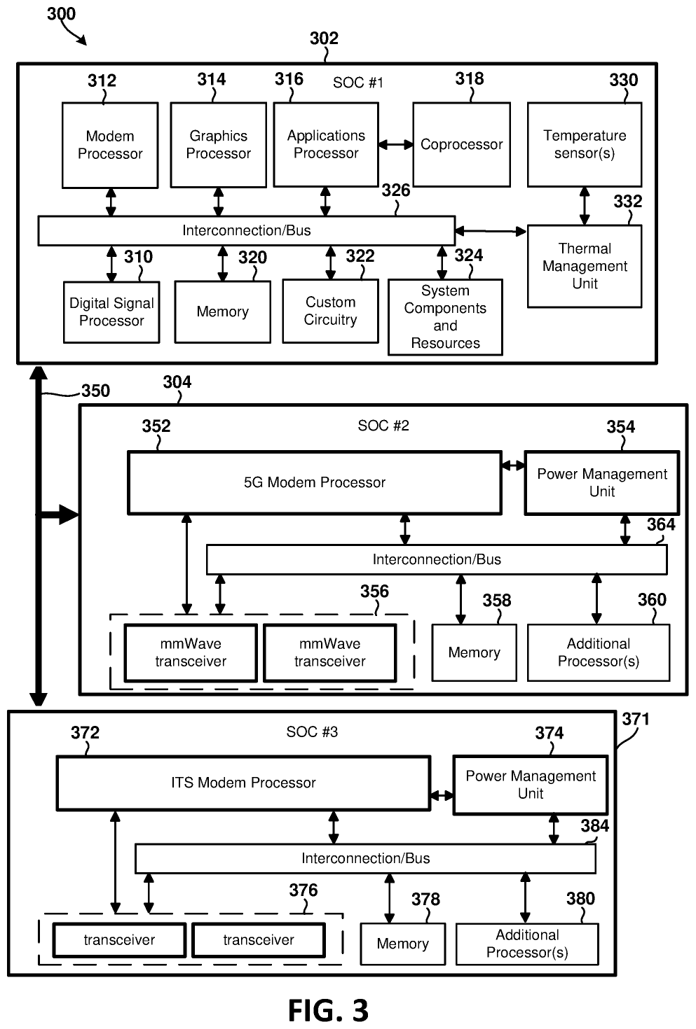

The various embodiments may be implemented on a number of single processor and multiprocessor communication devices, including an SoC and/or an SIP. FIG. 3 illustrates an example SIP 300 architecture that may be configured to implement methods for sending path history in accordance with various embodiments. With reference to FIGS. 1A-3, example SIP 300 architecture may be implemented in any SIP, and may be used in any communication device (e.g., in-vehicle communication device 140, in-vehicle communication device 152, in-vehicle communication device 153, Road Side Unit 158, 159, etc.) implementing various embodiments.

In the example illustrated in FIG. 3, the SIP 300 includes three SoCs 302, 304, 371. In some embodiments, the first SoC 302 may operate as a central processing unit (CPU) of the communication device that carries out the instructions of software application programs by performing the arithmetic, logical, control and input/output (I/O) operations specified by the instructions. In some embodiments, the second SoC 304 may operate as a specialized processing unit. For example, the second SoC 304 may operate as a specialized 5G processing unit responsible for managing high volume, high speed (e.g., 5 Gbps, etc.), and/or very high frequency short wave length (e.g., 28 GHz mmWave spectrum, etc.) communications to support 5G NR functionality with an air interface based on OFDM. In some embodiments, the third SoC 371 may operate as a specialized processing unit. For example, the third SoC 371 may operate as a specialized C-V2X processing unit responsible for managing V2V, V2I, and V2P communications over D2D links, such as D2D links establish in the dedicated ITS 5.9 GHz spectrum communications. The SoCs and organization of functionality illustrated in FIG. 3 are a non-limiting example of a SIP as other architectures and organizations of functionality among SoCs, including fewer or more SoCs, are contemplated.

In the example illustrated in FIG. 3, the first SoC 302 includes a digital Signal processor (DSP) 310, a modem processor 312, a graphics processor 314, an application processor 316, one or more coprocessors 318 (e.g., vector co-processor) connected to one or more of the processors, memory 320, custom circuity 322, system components and resources 324, an interconnection/bus module 326, one or more temperature sensors 330, and a thermal management unit 332. The second SoC 304 includes a 5G modem processor 352, a power management unit 354, an interconnection/bus module 364, a plurality of mmWave transceivers 356, memory 358, and various additional processors 360, such as an applications processor, packet processor, etc. The third SoC 371 includes an ITS modem processor 372, a power management unit 374, an interconnection/bus module 384, a plurality of transceivers 376 (e.g., transceivers configured to operate in the dedicated ITS 5.9 GHz spectrum), memory 378, and various additional processors 380, such as an applications processor, packet processor, etc.

Each processor 310, 312, 314, 316, 318, 352, 360, 372, 380 may include one or more cores, and each processor/core may perform operations independent of the other processors/cores. For example, the first SoC 302 may include a processor that executes a first type of operating system (e.g., FreeBSD, LINUX, OS X, etc.) and a processor that executes a second type of operating system (e.g., MICROSOFT WINDOWS 10). In addition, any or all of the processors 310, 312, 314, 316, 318, 352, 360, 372, 380 may be included as part of a processor cluster architecture (e.g., a synchronous processor cluster architecture, an asynchronous or heterogeneous processor cluster architecture, etc.).

The first, second, and third SoCs 302, 304, 371 may include various system components, resources and custom circuitry for managing sensor data, analog-to-digital conversions, wireless data transmissions, and for performing other specialized operations, such as decoding data packets and processing encoded audio and video signals for rendering in a web browser or other display application. For example, the system components and resources 324 of the first SoC 302 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 324 and/or custom circuitry 322 may also include circuitry to interface with peripheral devices, such as cameras, electronic displays, wireless communication devices, external memory chips, autonomous driving systems, traffic sign recognition systems, parking assistance systems, telematics units, tire pressure monitoring systems, collision warning systems, display systems, ADASs, vehicle buses, etc.

The first, second, and third SoCs 302, 304, 371 may communicate via one or more interconnection/bus modules 350. The processors 310, 312, 314, 316, 318 may be interconnected to one or more memory elements 320, system components and resources 324, and custom circuitry 322, and a thermal management unit 332 via an interconnection/bus module 326. Similarly, the processors 352, 360 may be interconnected to the power management unit 354, the mmWave transceivers 356, memory 358, and various additional processors 360 via the interconnection/bus module 364. Similarly, the processors 372, 380 may be interconnected to the power management unit 374, the transceivers 376, memory 378, and various additional processors 380 via the interconnection/bus module 384. The interconnection/bus module 326, 350, 364, 384 may include an array of reconfigurable logic gates and/or implement a bus architecture (e.g., CoreConnect, AMBA, etc.). Communications may be provided by advanced interconnects, such as high-performance networks-on chip (NoCs).

The first, second, and/or third SoCs 302, 304, 371 may further include an input/output module (not illustrated) for communicating with resources external to the SoCs. Resources external to the SoCs may be shared by two or more of the internal SoC processors/cores.

In addition to the SIP 300 discussed above, the various aspects may be implemented in a wide variety of communication devices, which may include a single processor, multiple processors, multicore processors, or any combination thereof.

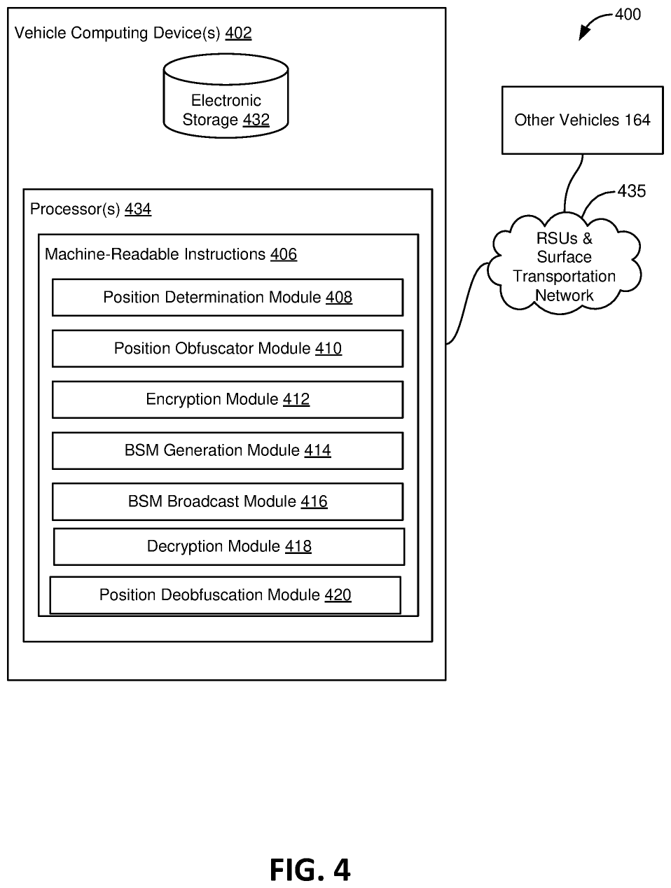

FIG. 4 shows a component block diagram illustrating a system 400 configured to provide elevation information in Broadcast Safety Messages (BSMs) sent from a vehicle in accordance with various embodiments. In some embodiments, the system 400 may include one or more vehicle computing devices 402 and/or one or more network servers 166. With reference to FIGS. 1A-4, the vehicle computing device(s) 402 may be similar to the vehicle computing device 140, 152, 153 and include a processor (e.g., 164) or a processing device (e.g., 300) (referred to as a “processor”) of a vehicle (e.g., 100, 162, 164, 230).

The vehicle computing device(s) 402 may be configured by machine-executable instructions 406. Machine-executable instructions 406 may include one or more instruction modules. The instruction modules may include computer program modules. The instruction modules may include one or more of a position determination module 408, a position obfuscator module 410, an encryption module 412, a BSM generation module 414, BSM broadcast module 416, a decryption module 418, and a position deobfuscation module 420.

Vehicle computing device(s) 402 may include electronic storage 432, one or more processors 434, and/or other components. Vehicle computing device(s) 402 may include communication lines, or ports to enable the exchange of information with a network and/or other computing platforms. Illustration of vehicle computing device(s) 402 in FIG. 4 is not intended to be limiting.

Electronic storage 432 may include non-transitory storage media that electronically stores information. The electronic storage media of electronic storage 432 may include one or both of system storage that is provided integrally (i.e., substantially non-removable) with vehicle computing device(s) 402 and/or removable storage that is removably connectable to vehicle computing device(s) 402 via, for example, a port (e.g., a universal serial bus (USB) port, a firewire port, etc.) or a drive (e.g., a disk drive, etc.). Electronic storage 432 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 432 may include one or more virtual storage resources (e.g., cloud storage, a virtual private network, and/or other virtual storage resources). Electronic storage 432 may store software algorithms, information determined by processor(s) 434, information received from computing platform(s) 402, information received from authorized party computing platform(s) 404, and/or other information that enables vehicle computing device(s) 402 to function as described herein.

Processor(s) 434 may be configured to provide information processing capabilities in vehicle computing device(s) 402. As such, processor(s) 434 may include one or more of a digital processor, an analog processor, a digital circuit designed to process information, an analog circuit designed to process information, a state machine, and/or other mechanisms for electronically processing information. Although processor(s) 434 is shown in FIG. 4 as a single entity, this is for illustrative purposes only. In some implementations, processor(s) 434 may include a plurality of processing units. These processing units may be physically located within the same device, or processor(s) 434 may represent processing functionality of a plurality of devices operating in coordination. Processor(s) 434 may be configured to execute modules 408-420, and/or other modules. Processor(s) 434 may be configured to execute modules 408-420, and/or other modules by software; hardware; firmware; some combination of software, hardware, and/or firmware; and/or other mechanisms for configuring processing capabilities on processor(s) 434. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408-420 are illustrated in FIG. 4 as being implemented within a single processing unit, in implementations in which processor(s) 434 includes multiple processing units, one or more of modules 408-420 may be implemented remotely from the other modules. The description of the functionality provided by the different modules 408-420 described below is for illustrative purposes, and is not intended to be limiting, as any of modules 408-420 may provide more or less functionality than is described. For example, one or more of modules 408-420 may be eliminated, and some or all of its functionality may be provided by other ones of modules 408-420. As another example, processor(s) 434 may be configured to execute one or more additional modules that may perform some or all of the functionality attributed below to one of modules 408-420.

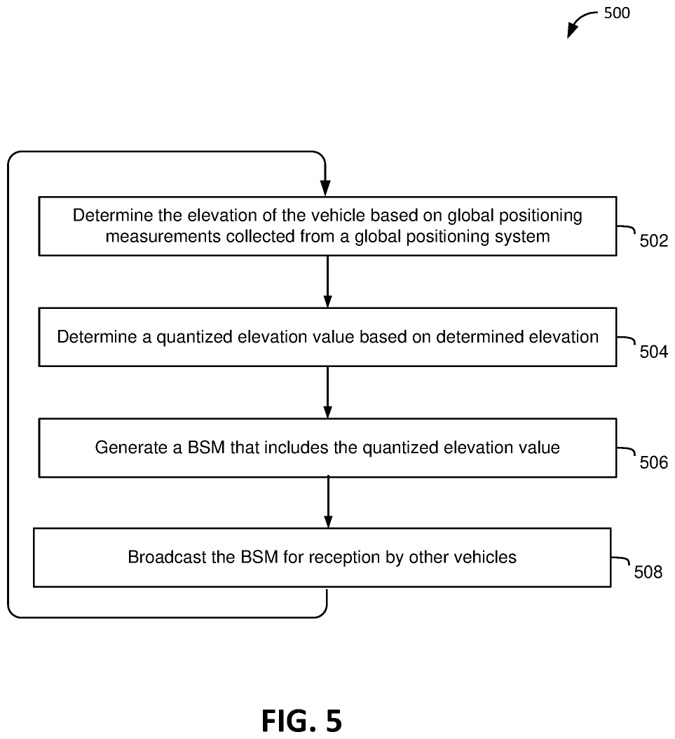

FIGS. 5-7 are process flow diagrams illustrating methods 500, 600, 700 for providing position information when broadcasting Broadcast Safety Messages (BSMs) in accordance with various embodiments. The methods 500, 600, 700 may be performed by a processor (e.g., processor 204, 310-318, 434, etc.) in an in-vehicle communication device.

With reference to FIG. 5, in block 502 of method 500, the in-vehicle communication device may determine an elevation of the vehicle by a global navigation satellite system (GNSS) receiver.

In block 504, the in-vehicle communication device may determine a quantized elevation value based on the determined elevation. The quantized elevation value may be computed so that it is less precise than the determined elevation, but sufficiently precise to inform other vehicles of a roadway level on which the vehicle is traveling. In some embodiments, the in-vehicle communication device may determine the quantized elevation value by dividing the elevation value competed in block 502 by an integer step value to generate a quotient, and round the quotient to an integer or whole number. In some embodiments, in block 504, the in-vehicle communication device may determine or select the integer step value so that the resulting quantized elevation values are sufficiently generalized (or made less precise) so that the elevation information complies with the relevant regulations, but is still sufficiently precise to inform other vehicles whether the vehicle is at grade (at ground level) or of the number of roadway levels that the vehicle is above or below grade. In some embodiments, in block 504, the in-vehicle communication device may select an integer step value of 3 meters.

In block 506, the in-vehicle communication device may generate a BSM that includes the quantized elevation value. In some embodiments, the in-vehicle communication device may generate the BSM to includes an integer between -1229 and 18432. The integer may represent the number of steps above or below a reference ellipsoid. In block 506, the in-vehicle communication device may broadcast the BSM for reception by other vehicles.

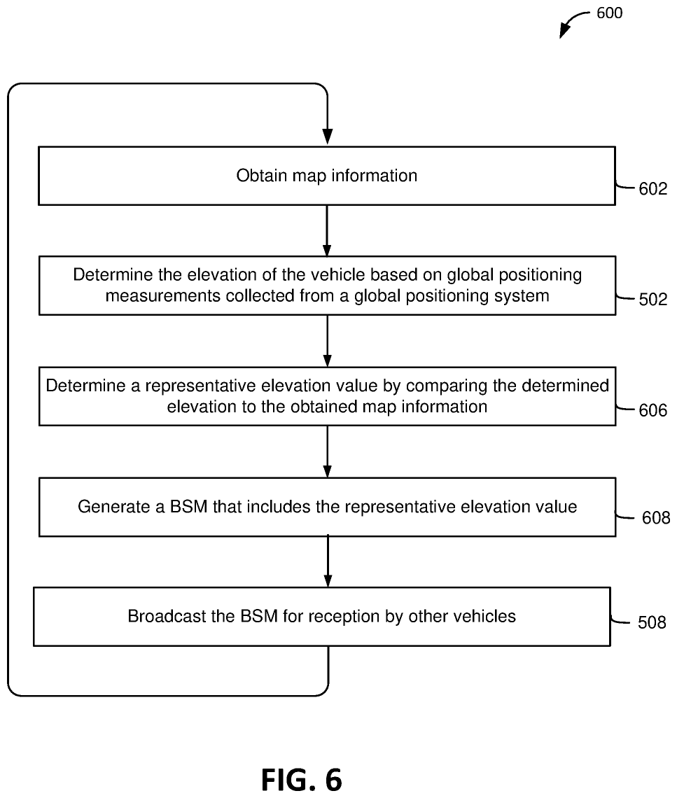

With reference to FIG. 6, in block 602 of method 600, the in-vehicle communication device may obtain map information. For example, in-vehicle communication device may receive map information from a vehicle-to-everything (V2X) MAP message, downloading map information from a third-party vendor, or accessing and retrieve map information that is preloaded in a local memory.

In block 502, the in-vehicle communication device may determine an elevation of the vehicle by a global navigation satellite system (GNSS) receiver.

In block 606, the in-vehicle communication device may determine a representative elevation value by comparing the determined elevation to the obtained map information. For example, the in-vehicle communication device may determine a representative value that indicates whether the vehicle is at grade (at ground level) or the number of roadway levels that the vehicle is above or below grade. In some embodiments, the in-vehicle communication device may determine the representative elevation value based on a result of comparing the determined elevation to a three-dimensional map. In some embodiments, the in-vehicle communication device may determine the representative elevation value based on a two-dimensional map and simple reckoning techniques.

In block 608, the in-vehicle communication device may generate a BSM that includes the representative elevation value. In some embodiments, the in-vehicle communication device may generate the BSM to include an elevation value (e.g., an integer between −8 and 8, inclusive etc.) that represents the number of steps or roadway levels that the vehicle is above or below a reference point/grade. In block 508, the in-vehicle communication device may broadcast the BSM for reception by other vehicles.

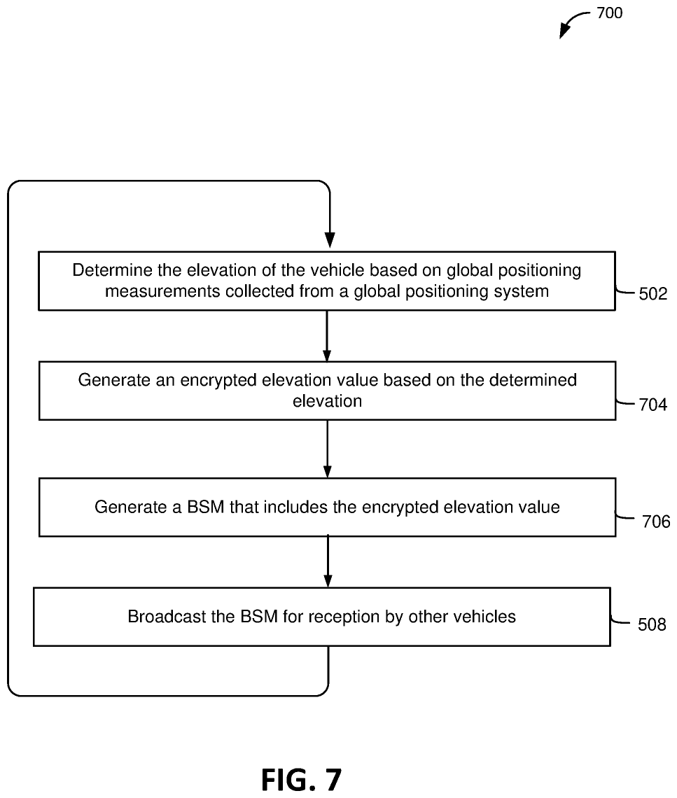

With reference to FIG. 7, in block 502 of method 700, the in-vehicle communication device may determine an elevation of the vehicle by a global navigation satellite system (GNSS) receiver.

In block 704, the in-vehicle communication device may generate an encrypted elevation value based on the determined elevation. In some embodiments, the in-vehicle communication device may generate the encrypted elevation value based on the determined elevation using a simple encryption algorithm, which may to reduce processing and communication resources used to encrypt, transmit and/or decrypt the elevation.

In block 706, the in-vehicle communication device may generate a BSM that includes the encrypted elevation value. In block 508, the in-vehicle communication device may broadcast the BSM for reception by other vehicles.

Implementation examples are described in the following paragraphs. While some of the following implementation examples are described in terms of example methods, further example implementations may include: the example methods discussed in the following paragraphs implemented by a V2X system processor that may be an onboard unit, mobile device unit, mobile computing unit, or stationary roadside unit including a processor configured with processor-executable instructions to perform operations of the methods of the following implementation examples; the example methods discussed in the following paragraphs implemented by a V2X system including means for performing functions of the methods of the following implementation examples; and the example methods discussed in the following paragraphs may be implemented as a non-transitory processor-readable storage medium having stored thereon processor-executable instructions configured to cause a V2X system processor to perform the operations of the methods of the following implementation examples.

Example 1. A method performed in a processor of a vehicle for providing position information when broadcasting Broadcast Safety Messages (BSMs), including: determining an elevation of the vehicle by a global navigation satellite system (GNSS) receiver; determining a quantized elevation value based on the determined elevation, the quantized elevation value being less precise than the determined elevation but with sufficient precision to inform other vehicles of a roadway level on which the vehicle is traveling; and broadcasting a BSM that includes the quantized elevation value for reception by other vehicles.

Example 2. The method of example 1, in which determining the quantized elevation value based on the determined elevation, the quantized elevation value being less precise than the determined elevation but with sufficient precision to inform other vehicles of the roadway level on which the vehicle is traveling includes: dividing the determined elevation by an integer step value to generate a quotient; and rounding the quotient to an integer or whole number.

Example 3. The method of example 2, in which dividing the determined elevation by the integer step value to generate the quotient further includes determining the integer step value so that the resulting quantized elevation values are sufficiently generalized so that broadcast elevation information complies with relevant regulations.

Example 4. The method of example 2, in which dividing the determined elevation by the integer step value to generate the quotient further includes determining the integer step value so that the resulting quantized elevation values are sufficiently precise to inform other vehicles whether the vehicle is at grade or of a number of roadway levels that the vehicle is above or below grade.

Example 5. The method of any of examples 2-4, in which the integer step value is three meters.

Example 6. The method of any of examples 1-5, in which broadcasting the BSM that includes the quantized elevation value for reception by other vehicles includes broadcasting a BSM that includes an integer between −1229 and 18432 representing a number of steps above or below a reference ellipsoid.

Example 7. A method performed in a processor of a vehicle for providing position information when broadcasting Broadcast Safety Messages (BSMs), including: obtaining map information; determining an elevation of the vehicle by a global navigation satellite system (GNSS) receiver; determining a representative elevation value by comparing the determined elevation to the obtained map information; generating a BSM that includes the representative elevation value; and broadcasting the BSM for reception by other vehicles.

Example 8. The method of example 7, in which determining the representative elevation value by comparing the determined elevation to the obtained map information includes determining a representative elevation value that indicates: whether the vehicle is at grade; a number of roadway levels that the vehicle is below grade; or a number of roadway levels that the vehicle is above grade.

Example 9. The method of any of examples 7-8, in which generating the BSM that includes the representative elevation value includes generating the BSM to include an elevation value that represents a number of steps or roadway levels that the vehicle is above or below a reference point or grade.

Example 10. The method of any of examples 7-9, in which obtaining map information includes one or more of: receiving map information from a vehicle-to-everything (V2X) MAP message; downloading map information from a third-party vendor; or accessing map information preloaded in local memory.

Example 11. The method of any of examples 7-10, in which determining the representative elevation value by comparing the determined elevation to the obtained map information includes determining the representative elevation value by comparing the determined elevation to a three-dimensional map.

Example 12. The method of any of examples 7-11, in which determining the representative elevation value by comparing the determined elevation to the obtained map information includes determining the representative elevation value based on a two-dimensional map and simple reckoning.

The processors implementing various embodiments may be any programmable microprocessor, microcomputer or multiple processor chip or chips that can be configured by software instructions (applications) to perform a variety of functions, including the functions of the various aspects described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iden), C-V2X, V2V, V2P, V2I, and V2N, etc. Each of these technologies involves, for example, the transmission and reception of voice, data, signaling, and/or content Messages. It should be understood that any references to terminology and/or technical details related to an individual telecommunication standard or technology are for illustrative purposes only, and are not intended to limit the scope of the claims to a particular communication system or technology unless specifically recited in the claim language.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital Signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method performed in a processor of a vehicle for providing position information when broadcasting Broadcast Safety Messages (BSMs), comprising:
determining an elevation of the vehicle by a global navigation satellite system (GNSS) receiver;
determining a quantized elevation value based on the determined elevation, the quantized elevation value being less precise than the determined elevation but with sufficient precision to inform other vehicles of a roadway level on which the vehicle is traveling; and
broadcasting a BSM that includes the quantized elevation value for reception by other vehicles.

2. The method of claim 1, wherein determining the quantized elevation value based on the determined elevation, the quantized elevation value being less precise than the determined elevation but with sufficient precision to inform other vehicles of the roadway level on which the vehicle is traveling comprises:
dividing the determined elevation by an integer step value to generate a quotient; and
rounding the quotient to an integer or whole number.

3. The method of claim 2, wherein dividing the determined elevation by the integer step value to generate the quotient further comprises determining the integer step value so that the resulting quantized elevation values are sufficiently generalized so that broadcast elevation information complies with relevant regulations.

4. The method of claim 2, wherein dividing the determined elevation by the integer step value to generate the quotient further comprises determining the integer step value so that the resulting quantized elevation values are sufficiently precise to inform other vehicles whether the vehicle is at grade or of a number of roadway levels that the vehicle is above or below grade.

5. The method of claim 2, wherein the integer step value is three meters.

6. The method of claim 1, wherein broadcasting the BSM that includes the quantized elevation value for reception by other vehicles comprises broadcasting a BSM that includes an integer between −1229 and 18432 representing a number of steps above or below a reference ellipsoid.

7. A method performed in a processor of a vehicle for providing position information when broadcasting Broadcast Safety Messages (BSMs), comprising:
obtaining map information;
determining an elevation of the vehicle by a global navigation satellite system (GNSS) receiver;
determining a representative elevation value by comparing the determined elevation to the obtained map information;
generating a BSM that includes the representative elevation value; and
broadcasting the BSM for reception by other vehicles.

8. The method of claim 7, wherein determining the representative elevation value by comparing the determined elevation to the obtained map information comprises determining a representative elevation value that indicates:
whether the vehicle is at grade;
a number of roadway levels that the vehicle is below grade; or
a number of roadway levels that the vehicle is above grade.

9. The method of claim 7, wherein generating the BSM that includes the representative elevation value comprises generating the BSM to include an elevation value that represents a number of steps or roadway levels that the vehicle is above or below a reference point or grade.

10. The method of claim 7, wherein obtaining map information comprises one or more of:
receiving map information from a vehicle-to-everything (V2X) MAP message;
downloading map information from a third-party vendor; or
accessing map information preloaded in local memory.

11. The method of claim 7, wherein determining the representative elevation value by comparing the determined elevation to the obtained map information comprises determining the representative elevation value by comparing the determined elevation to a three-dimensional map.

12. The method of claim 7, wherein determining the representative elevation value by comparing the determined elevation to the obtained map information comprises determining the representative elevation value based on a two-dimensional map and simple reckoning.

13. A method performed in a processor of a vehicle for providing position information when broadcasting Broadcast Safety Messages (BSMs), comprising:
determining an elevation of the vehicle by a global navigation satellite system (GNSS) receiver;
generating an encrypted elevation value based on the determined elevation;
generating a BSM that includes the encrypted elevation value; and
broadcasting the BSM for reception by other vehicles.

14. The method of claim 13, further comprising using a certification process to obtain permissions necessary to transmit the encrypted elevation value.

15. The method of claim 13, wherein generating the encrypted elevation value based on the determined elevation comprises using a group encryption key that is provided to every approved receiver device or vehicle in advance of the broadcast.

16. A vehicle communication system, comprising:
a processor configured with processor-executable instructions to:
determine an elevation of the vehicle communication system by a global navigation satellite system (GNSS) receiver;
determine a quantized elevation value based on the determined elevation, the quantized elevation value being less precise than the determined elevation but with sufficient precision to inform other vehicles of a roadway level on which the vehicle is traveling; and
broadcast a Broadcast Safety Message (BSM) that includes the quantized elevation value for reception by other vehicles.

17. The vehicle communication system of claim 16, wherein the processor is further configured with processor-executable instructions to determine the quantized elevation value based on determined elevation by:
dividing the determined elevation by an integer step value to generate a quotient; and
rounding the quotient to an integer or whole number.

18. The vehicle communication system of claim 17, wherein the processor is further configured with processor-executable instructions to determine the integer step value so that the resulting quantized elevation values are sufficiently generalized so that broadcast elevation information complies with relevant regulations.

19. The vehicle communication system of claim 17, wherein the processor is further configured with processor-executable instructions to determine the integer step value so that the resulting quantized elevation values are sufficiently precise to inform other vehicles whether the vehicle is at grade or of a number of roadway levels that the vehicle is above or below grade.

20. The vehicle communication system of claim 17, wherein the integer step value is three meters.

21. The vehicle communication system of claim 16, wherein the quantized elevation value is an integer between −1229 and 18432 representing a number of steps above or below a reference ellipsoid.

22. A vehicle communication system, comprising:
a processor configured with processor-executable instructions to:
obtain map information;
receive elevation information from a GNSS receiver;
determine a representative elevation value by comparing the determined elevation to the obtained map information;
generate a BSM that includes the representative elevation value; and
broadcast the BSM for reception by other vehicles.

23. The vehicle communication system of claim 22, wherein the processor is further configured with processor-executable instructions to determine the representative elevation value that indicates:
whether the vehicle is at grade;
a number of roadway levels that the vehicle is below grade; or
a number of roadway levels that the vehicle is above grade.

24. The vehicle communication system of claim 22, wherein the processor is further configured with processor-executable instructions to generate the BSM that includes an elevation value that represents a number of steps or roadway levels that the vehicle is above or below a reference point or grade.

25. The vehicle communication system of claim 22, wherein the processor is further configured with processor-executable instructions to obtain map information by one or more of:
receiving map information from a vehicle-to-everything (V2X) MAP message;
downloading map information from a third-party vendor; or
accessing map information preloaded in local memory.

26. The vehicle communication system of claim 22, wherein the processor is further configured with processor-executable instructions to determine the representative elevation value by comparing the determined elevation to a three-dimensional map.

27. The vehicle communication system of claim 22, wherein the processor is further configured with processor-executable instructions to determine the representative elevation value based on a two-dimensional map and simple reckoning.

28. A vehicle communication system, comprising:
a processor configured with processor-executable instructions to:
determine an elevation of a vehicle using information from a GNSS receiver;
generate an encrypted elevation value based on the determined elevation;
generate a BSM that includes the encrypted elevation value; and
broadcast the BSM for reception by other vehicles.

29. The vehicle communication system of claim 28, wherein the processor is further configured with processor-executable instructions to use a certification process to obtain permissions necessary to transmit the encrypted elevation value.

30. The vehicle communication system of claim 28, wherein the processor is further configured with processor-executable instructions to generate the encrypted elevation value based on the determined elevation using a group encryption key that is provided to every approved receiver device or vehicle in advance of the broadcast.
